(19) United States
(12) Patent Application Publication
(10) Pub. No.: US 2018/0050556 A1
(43) Pub. Date: Feb. 22, 2018

(54) FILE

(71) Applicant: King Jim Co, Ltd, Tokyo (JP)

(72) Inventor: Tatsuya Haneda, Tokyo (JP)

(21) Appl. No.: 15/679,430

(22) Filed: Aug. 17, 2017

(30) Foreign Application Priority Data
Aug. 22, 2016 (JP) 2016-161907

(51) Int. Cl. B42F 7/02

(52) U.S. Cl. CPC B42F 7/02

(57) ABSTRACT

A structure of the base plate for preventing movement of the slider in the direction different from the movement direction is simplified. There is provided a file having a structure in which a protrusion and an erected wall are not provided in a slider, a guide plate and the like are not provided in a base plate by welding or adhesion, and movement of the slider is regulated to a predetermined position in a predetermined direction.

### CROSS-REFERENCE TO RELATED APPLICATION

This application is based upon and claims the benefit of prior Japanese Patent Application No. 2016-161907 filed on Oct. 22, 2016, the entire contents of which are incorporated herein by reference.

### FIELD

The present invention relates to a file, in which a slider having a substantially U-shaped cross-section and having elastic force sandwiches upper and lower surfaces of an end of a base plate, and it is selected by moving the slider with respect to the base plate in a state where a document is placed on the upper surface of the base plate whether or not the document is held. Additionally, the present invention implements prevention of movement of the slider in the direction different from the advancing/retreating direction of movement for selecting whether or not a document is held, and implements a function of regulating the movement of the slider so as to reliably stop at a position where the slider holds a document and a position where the slider does not hold the document when the slider is located at the respective positions, with a simple structure.

### BACKGROUND

There is known a paper clip including a base plate, an elastic slider, and a pressing plate, wherein the elastic slider slidably sandwiches upper and lower surfaces of an end of the base plate, the base plate includes movement regulating means that is composed of: guide plates provided orthogonal to a flat surface of the base plate at both edges of the end of the base plate so as to regulate movement in the direction orthogonal to the advancing/retreating direction of the elastic slider; a rim that is connected between these guide plates, and erected on the upper surface of the end of the base plate; holes that each have a predetermined width, are formed at both corner parts of the end of the base plate surrounded by this rim and the guide plates; a stopper that is formed by extending both ends of the rim of parts corresponding to the holes up to a back surface of the base plate; and a bottom plate formed at positions corresponding to the holes and connected to ends of the guide plates on the back surface side of the base plate and the ends of the rim. (for example, Patent document 1).

The guide plates of this paper clip include a pair of pins that extends toward the respective facing guide plates on respective facing surfaces, and is provided so as to be swingable to the elastic slider, and be able to engage/disengage with/from the elastic slider, and the pressing plate is supported so as to be swingable to the base plate through the pair of pins.

Furthermore, the stopper regulates movement of the elastic slider when the elastic slider moves in the pulling-out direction with respect to the base plate, and this stopper and a stepped unit provided on the bottom surface of the rim regulate movement of the elastic slider when the elastic slider moves in the pushing-in direction with respect to the base plate.

In addition to this, there is known a slide file having a back cover, a slider, and a front cover, wherein the slider movably sandwiches an upper surface near one side edge of the back cover and a lower side near the one side edge of the front cover in a state where the upper surface of the back cover is overlapped with the front cover, and the slider is capable of reliably stopping at a fixed position by side surface regulating stoppers and transverse regulating stoppers, the side surface regulating stoppers being formed on the back cover by folding lug pieces formed on both ends of the one side edge toward a surface opposite to a surface facing the front cover, and adhering the lug pieces to the surface, and the transverse regulating stoppers being formed by folding portions located between the respective side surface regulating stoppers of the one side edge obliquely inwardly upward, namely in the direction opposite to the lug piece folding direction, and adhering and coupling proximal ends of the front cover while slightly remaining a distal end inside the inner surfaces, at the time of movement operation in the advancing/retreating of the slider (for example, Patent document 2).

In this slide file, when the slider moves in the pulling-out direction with respect to the back cover and the front cover, a protrusion that protrudes inward from a distal end of the slider comes into contact with distal ends of the transverse regulating stoppers, and when the slider moves in the pushing-in direction with respect to the back cover and the front cover, an erected wall erected on an inner deep part of the bottom surface of the slider comes into contact with end parts of the transverse regulating stoppers serving as connection parts of the back cover and the front cover, so that the movement of the slider in each direction is regulated.

[Patent document 1] Japanese Utility Model Registration No. 2597192

[Patent document 2] Japanese Utility Model Registration No. 2516918

### SUMMARY

### Technical Problem

However, in the conventional paper clip described in Patent document 1, the base plate and the pressing plate are swingably connected to each other through the guide plates provided in the base plate and the pins provided in the guide plates. In order to implement this structure, the guide plates and the pins need to be formed integrally with the base plate and the guide plates, respectively, or the guide plates and the pins need to be connected to the base plate and the guide plates, respectively, by welding or adhesion.

In such a paper clip, the elastic slider is brought into contact with the guide plates, so that movement in the direction orthogonal to the movement advancing/retreating direction is regulated. Additionally, movement in the advancing/retreating direction is further regulated by the stopper provided in the base plate.

Thus, the conventional paper clip inevitably needs to have a complicated structure. In a case where such a structure is implemented by integrated formation or formation by welding or adhesion, a material to be used (for example, polypropylene) is limited. Additionally, according to this structure, there is a problem that mounting of the pressing plate onto the base plate is not always easy.

Furthermore, in the conventional slide file described in Patent document 2, the protrusion that protrudes inward from the distal end of the slider regulates the movement of the slider in the pulling-out direction, and the erected wall erected on the inner deep part of the bottom surface of the slider regulates the movement of the slider in the pushing-in direction, and therefore there is a problem that this devised slider has a complicated shape which is not easily formed.

In addition, in such a slide file, in the one side end of the back cover, the side surface regulating stoppers and the transverse regulating stopper are formed by folding the respective lug pieces provided on the back cover, and therefore in a plate piece which forms the back cover having such lug pieces, in order that the back cover has a size corresponding to a document formed of a piece of paper with a general size (for example, A4 format defined in JIS S 5505), the plate piece has to have an irregular size or shape slightly larger than such size in consideration of the size of the lug pieces. On a manufacturing site of such a plate material, and a plate material having a size corresponding to a piece of paper with another general size, there is a problem that management of materials is not efficient.

The present invention has been made in order to solve such problems, and provides a file having a structure in which a protrusion and an erected wall are not provided in a slider, a guide plate, and the like are not provided in a base plate that secures a function of a back cover, and movement of the slider is regulated to a predetermined position in a predetermined direction.

### Solution to Problem

The present invention sandwiches a document and a document protective sheet placed on a base plate together with the base plate by elastic force of a slider, as described below.

That is, a file including: a base plate; and a slider slidably provided near an end of the base plate, wherein the slider sandwiches and files the base plate and a document placed on the base plate by elastic force, the base plate has regulating wall units erected on both side edges in the end, and the regulating wall units each regulate movement in a direction orthogonal to an advancing direction toward a holding position where the slider sandwiches the base plate and the document placed on the base plate and a retreating direction toward a non-holding position where the slider is separated from the holding position, and when the slider moves in the retreating direction to reach a predetermined position, the regulating wall units each come into contact with the slider to regulate movement in the retreating direction.

Additionally, the regulating wall units are formed by folding lug pieces obtained by cutting out the both side edges in the end of the base plate toward a surface opposite to a surface for allowing the document to be placed in the base plate.

Furthermore, the slider has cutout parts at positions that are both side edges of the slider, and face the respective lug pieces in a state where the slider is spliced to the base plate, and has retreat movement preventing units on boundaries between the cutout parts and portions where the cutout parts are not formed in an end of the slider, the retreat movement preventing units being formed to come into contact with the regulating wall units when the slider moves in the retreating direction to reach a predetermined position, and to prevent further movement.

In a virtual quadrangle in which a segment equivalent to a first side that is formed by one edge in the orthogonal direction to the slider advancing/retreating direction of base plate in each of both ends in the orthogonal direction in the end where the slider is disposed in the base plate, namely, near the corner parts of the base place, cutting lines are provided at portions equivalent to a second side and a fourth side that are each orthogonal to the first side, and face each other, a portion equivalent to a third side located at a position facing the first side is not cut in, so that a substantially quadrangular lug piece having a distal end being a portion equivalent to the first side is formed, each of the regulating wall units is formed by folding the lug piece toward the surface opposite to the surface for allowing the document to be placed in the base plate by use of the portion equivalent to the third side as a folding line. Therefore, a plate piece that forms the base plate may have a size corresponding to a document formed of a piece of paper with a general size without considering change in the shape or increase of the size of a plate material due to addition of the lug pieces. In addition, plate materials forming the lug pieces do not need to be mounted on the base plate by welding or adhesion. As long as either one of the second sides and the fourth sides (for example, the second sides) is located on the same virtual line as the end for allowing the slider to be disposed in the base plate, the cutting lines may be provided only in the other (for example, the fourth side).

In each cutout part provided in the slider, in a virtual quadrangle in which a segment equivalent to a first side is formed by the end of the slider at a position facing the lug piece with the slider sliced to the base plate in each of both side edges of the slider, portions equivalent to a second side and a fourth side that are each orthogonal to the first side, and face each other, and a third side located at a position facing the first side are cut in, so that the cutout part formed by cutting out each of the both side edges of the slider in a substantially quadrangle is formed. A distance from the first side to the third side of each cutout part may be substantially the same as a distance from the first side to the third side of each of the above lug pieces.

Consequently, when force for causing the slider to move on the base plate in the direction orthogonal to the advancing/retreating direction acts, orthogonal movement preventing units located at the portions equivalent to the third sides of the cutout parts of the slider come into contact with the regulating wall units, so that movement of the slider in the above direction is regulated. When the slider moves on the base plate in the retreating direction to reach a maximum pulling-out position being the predetermined position, the retreat movement preventing units located at either one of portions equivalent to the second sides and the fourth sides of the cutout parts come into contact with contact parts of the regulating wall units being either one of portions equivalent to the second sides and the fourth sides of the lug pieces, so that passing of the slider over the maximum pulling-out position, and further movement of the slider in the retreating direction are regulated.

In addition, the regulating wall units are formed such that distal ends facing folding lines are longer than lengths of the folding lines.

That is, in each of the regulating wall units, the first side forming the distal end of the lug piece is longer than the third side forming the folding line, and the second side and the fourth side that are in contact with the first side and third side do not form parallel relation, so that at least one located on the vertical inside of the base plate among the second side and the fourth side does not form a right angle with the first side and a right angle with the third side. In a case where the first side and the third side are parallel to each other, segments equivalent to these four sides may be provided so as to form a virtual trapezoid.

With the regulating wall units thus formed, the contact parts are inclined so as to expand toward the direction in which the regulating wall units are separated from the base plate, and therefore when the slider receives force for causing the slider to pass over the maximum pulling-out position on the base plate and further move in the retreating direction, action of force in the direction in which the slider and the base plate are separated from each other is prevented.

### Advantageous Effect of Invention

According to the present invention, a protrusion and an erected wall are not provided in the slider, and a guide plate and the like are not provided in the base plate that secures a function of a back cover, the passing of the slider over the maximum pulling-out position, and further movement of the slider in the retreating direction can be regulated, and the movement in the direction orthogonal to the advancing/retreating direction can be regulated. Therefore, working such as welding and adhesion for the base plate is unnecessary, a material difficult to be thus worked, for example, three-layer foam polypropylene sheet (sheet where both surfaces of a thick sheet formed of lightweight forming agent are sandwiched by a polypropylene thin sheet) or paperboard can be employed, and therefore there is an advantage that texture and appearance can be freely set without receiving restriction by the quality of a material.

In other words, the lug pieces formed by cutting out the both side edges of the base plate are folded toward the surface opposite to the surface for allowing the document to be placed in the base plate, so that the regulating wall units are formed, and therefore the regulating wall units can be provided in the base plate without welding or adhesion.

Even in a case where the guide plates or the like are not provided in the base plate, the file is formed so as to implement either a state where the regulating wall units come into contact with a part of both ends orthogonal to the advancing/retreating direction of the slider, or a state where the regulating wall units continue to be located near the both ends orthogonal to the advancing/retreating direction of the slider, when the slider moves, so that the slider does not pull out from a document holder in the direction orthogonal to the advancing/retreating direction.

Furthermore, even in a case where the protrusions or the erected walls are not provided in the slider, the file is formed such that the contact parts of the base plate come into contact with the retreat movement preventing units that are a part of each cutout part of the slider, when the force for causing the slider to pass beyond the maximum pulling-out position, and to further move in the retreating direction acts. Consequently, the slider does not pull out from the document hold unit in the direction orthogonal to the advancing/retreating direction.

### BRIEF DESCRIPTION OF THE DRAWINGS

FIG. 1 is a front view illustrating a file according to an embodiment of the present invention;

FIG. 2 is a front view of a base plate in a state where lug pieces are not folded;

FIG. 3 is an enlarged left side view of a base plate in a state the lug pieces are folded, in which a vertical intermediate part of the base plate is omitted;

FIG. 4 is a back view illustrating the file according to the embodiment of the present invention;

FIG. 5A is an enlarged view of the slider located at a position where the document is sandwiched;

FIG. 5B is an enlarged view of a cutout part and a vicinity thereof of the slider spliced to the base plate;

FIG. 6 is a side view of the slider;

FIG. 7A is a view illustrating a state where the slider illustrated in FIG. 6 is spliced to the base plate;

FIG. 7B is a view illustrating a state where the slider illustrated in FIG. 6 moves in such a direction so as to be separated from the base plate;

FIG. 8A is an enlarged schematic view illustrating a contact state of a contact part and a retreat movement preventing unit; and

FIG. 8B is an enlarged schematic view illustrating a contact state of a contact part and a retreat movement preventing unit.

### DESCRIPTION OF EMBODIMENT

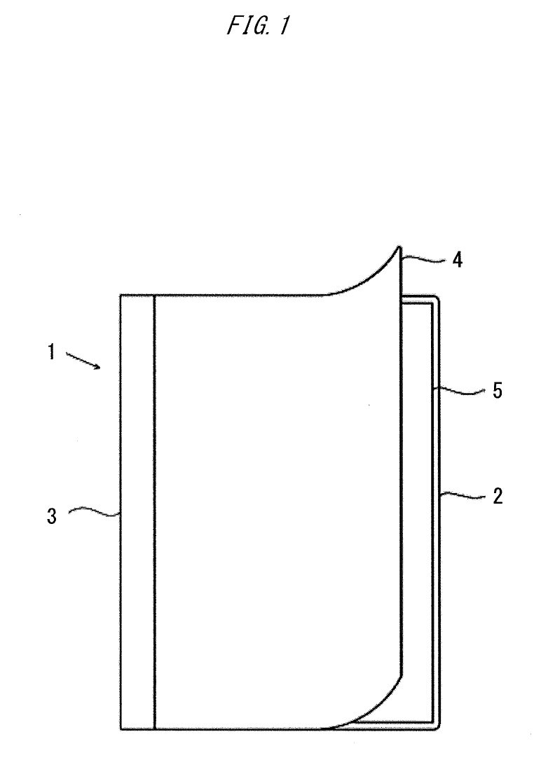

Hereinafter, an embodiment of the present invention will be described with reference to the drawings. In this specification, the vertical direction visually recognized in FIG. 1 is defined as the “vertical direction of a file”, and the horizontal direction visually recognized similarly is defined as the “ horizontal direction of a file”, unless otherwise stated.

A file 1 illustrated in FIG. 1 files a document 5 by overlapping a document protective sheet 4 on a base plate 2, sandwiching left ends of the document protective sheet and the base plate over the substantially whole vertical length by a slider 3 with elastic force of the slider 3, and further moving the slider 3 to a position where the document 5 is sandwiched in a state where the document 5 is inserted between the base plate 2 and the document protective sheet 4. The position where the slider 3 is disposed is not limited to the left end, and may be a right end, an upper end, or a lower end of the base plate. Additionally, the number of the sliders 3 to be disposed is not limited to 1, and a plurality of the sliders may be disposed.

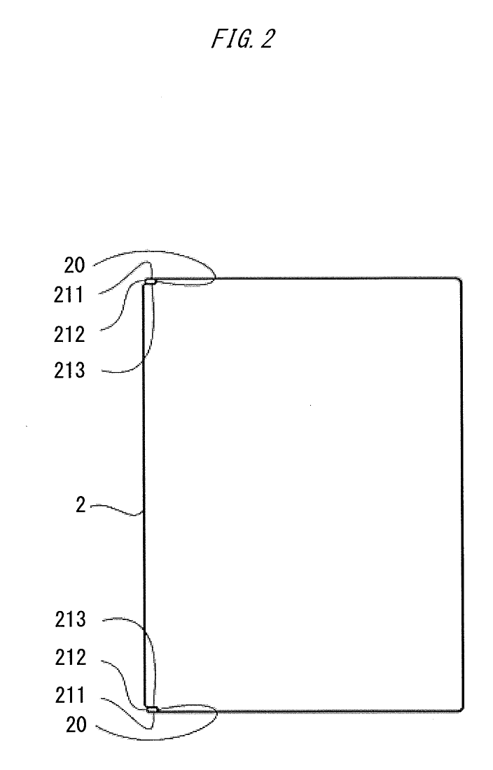

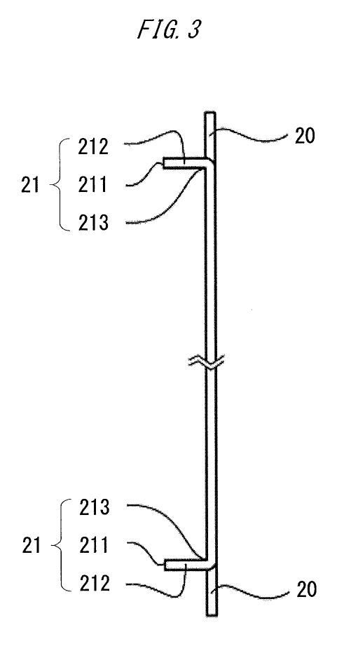

As illustrated in FIG. 2 and FIG. 3, in the base plate 2, cutting lines 20 are provided toward the vertical center of the base plate 2 from respective upper and lower ends near two corner parts which are upper and lower ends of a left end, so that lug pieces 21 having distal ends 211 that are edges located on the same virtual line as upper and lower edges of the base plate are formed, folding lines 213 that horizontally extend toward the left ends of the base plate 2 from ends near the vertical center of the base plate 2 of the cutting lines 20 are further provided, the lug pieces 21 are folded toward a surface opposite to a surface facing a pressing plate 34 of the slider 3 described below and the document protective sheet 4, with the folding lines 213 as base line, so that regulating wall units 21 that are erected to the base plate 2 are formed.

In each of the regulating wall units 21, when the distal end 211 is defined as a first side, a second end 212, and a contact part 214 that is an edge of the regulating wall unit 21 separated from the base plate by the cutting line 20 are defined as a second side and a fourth side, respectively, and the folding line 213 located at a position facing the distal end 211 is defined as a third side, virtual lines on the same lines as the first, second, third, and fourth sides are connected, and a virtual quadrangle is presented. However, as long as the lug pieces 21 are folded with the folding lines 213 as base lines, and the regulating wall units 21 are formed, the shape is not limited to the above shape. For example, any of or all of the distal ends 211, the second ends 212, and the contact parts 214 may be curved.

Furthermore, the second ends 212 may be located on the same virtual line as the left end of the base plate 2 in a state where the lug pieces 21 are not folded with the folding lines 213 as base lines, or the second ends 212 may be located at positions closer to the right than the proximal ends. Similarly, the distal ends 211 may be located on the same virtual line as the upper and lower ends of the base plate 2, or the distal ends 211 may be located at positions closer to vertical inside than the proximal ends.

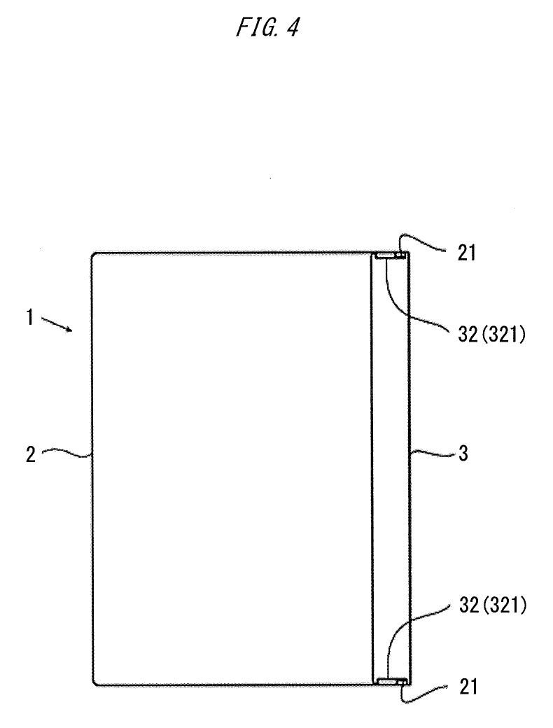

As illustrated in FIG. 4, when the slider 3 and the base plate 2 are combined, the regulating wall units 21 are located so as to be surrounded by cutout parts 32, any of ends forming the cutout parts 32 comes into contact with the regulating wall units 21, or continues to be located near the regulating wall units 21, so that movement of the slider 3 to the base plate 2 is regulated.

More specifically, in the slider 3, the cutout parts 32 formed by cutting out the slider toward vertical inside are formed at the upper and lower ends, a part of one of ends forming each of the cutout parts 32 comes into contact with the regulating wall unit 21, or continues to be located near the regulating wall unit 21 in a state where the slider is spliced to the base plate 2, so that the one of ends forms orthogonal movement preventing units 321 that regulate movement of the slider 3 in the vertical direction, namely in the direction orthogonal to the advancing/retreating direction.

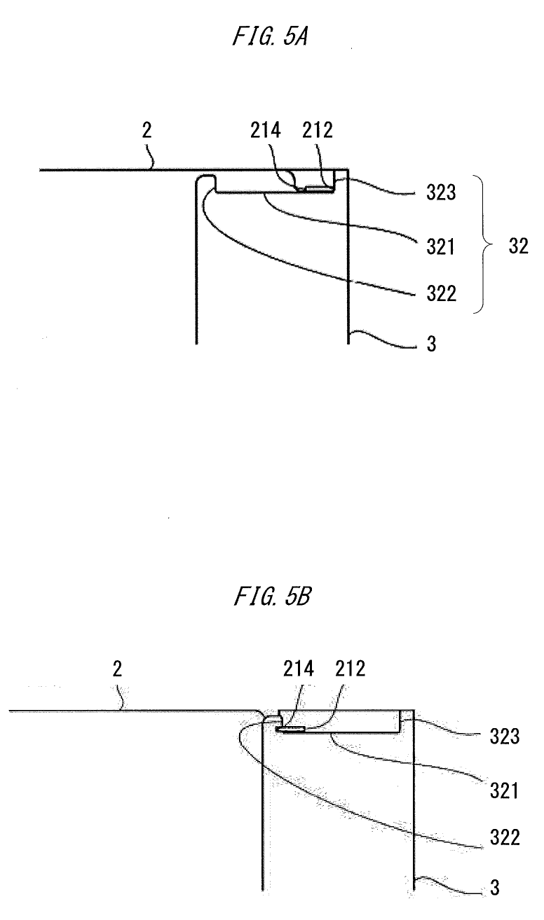

When the slider 3 is located at a position where the document 5 is sandwiched illustrated in FIG. 5A, the document 5 is filed. Then, when the slider moves in the retreating direction from the above position (to the left in FIG. 1, to the right in FIG. 5), the one end of the ends forming the cutout parts 32 reaches such a position as to come into contact with the contact part 214 that is one end of the regulating wall unit 21, as illustrated in FIG. 5B, so that passing of the slider over a maximum pulling-out position, and further movement of the slider in the retreating direction are regulated. That is, the one end forms a retreat movement preventing unit 322, and an end facing the retreat movement preventing units 322 forms a third end 323.

Thus, the regulating wall units 21 come into contact with the orthogonal movement preventing units 321 or continues to be located near the orthogonal movement preventing units 321, so that the vertical movement of the slider 3 is regulated, and when the slider reaches the maximum pulling-out position, the contact parts 214 come into contact with the retreat movement preventing units 322, so that the movement of the slider in the retreating direction is regulated.

The regulating wall units 21 are thus formed with respect to the cutout parts 32, and therefore when the horizontal lengths of the regulating wall units 21 are set to be short, a movement range of the slider 3 is increased. However, the areas of the regulating wall units 21 become small due to such short lengths, and therefore durability is low. When the horizontal lengths of the regulating wall units 21 are set to be long, the movement range of the slider 3 is shortened. However, the areas of the regulating wall units 21 can be increased, and therefore durability is high. That is, the horizontal lengths of the regulating wall units 21 may be determined in accordance with various conditions such as the size of a file, and the number of sheets of the document 5 to be stored.

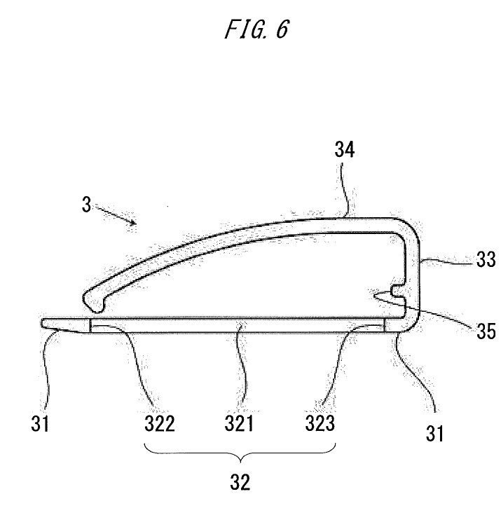

As illustrated in FIG. 6, the slider 3 has a movable plate 31 that is located at a lower part in this figure, and moves on a surface of the base plate 2, a rising plate 33 that extends upward in this figure from the movable plate 31, and the pressing plate 34 that extends from the rising plate 33 to the left (to the right in FIG. 1) visually recognized in this figure, and is integrally formed of resin having suitable elasticity, has a substantially U-shaped cross-section, and sandwiches the base plate 2 and the document protective sheet 4 placed on the base plate 2 in order to prevent damage resulting from direct contact of the pressing plate 34 and the document 5 between the movable plate 31 and the pressing plate 34.

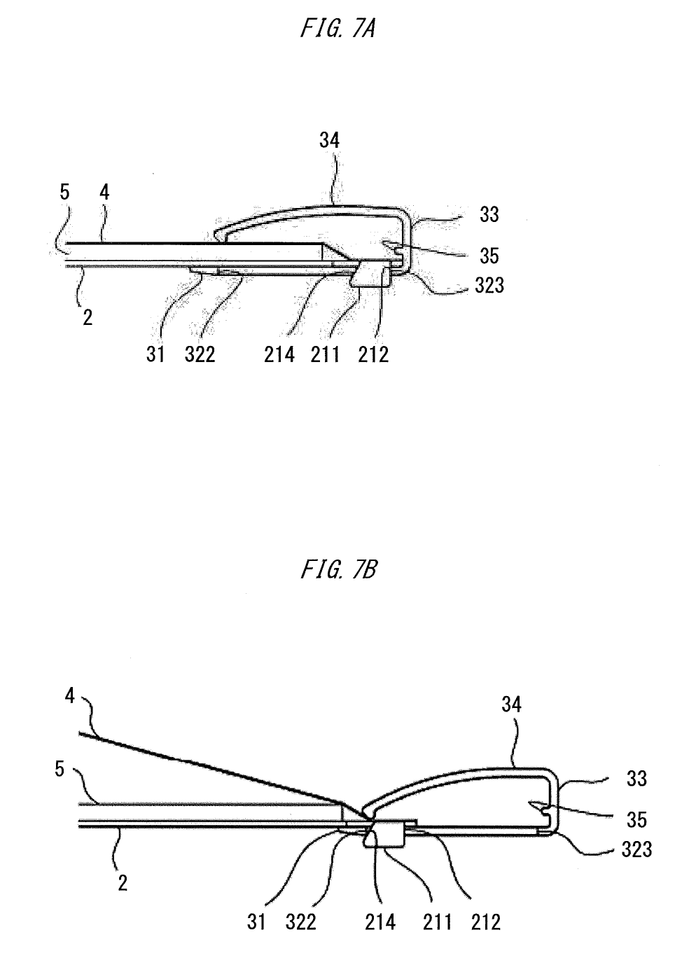

As illustrated in FIG. 1 and FIG. 4, the whole vertical length of the slider 3 is set to be substantially equal to the whole vertical length of the base plate 2. As illustrated in FIG. 7A, when the slider 3 moves in such a direction as to come close to the end of the base plate 2, and the third ends 323 come into contact with the regulating wall units 21 or the slider 3 reaches a position where the end of the base plate 2 comes into contact with an inner surface of the rising plate 33, namely a maximum pushing-in position, the slider 3 presses the document protective sheet 4 in the direction in which the document protective sheet 4 comes close to the base plate 2, so that the slider 3 holds the document 5 disposed between the base plate 2 and the document protective sheet 4. As illustrated in FIG. 7B, when the slider 3 moves in such a direction so as to be separated from the end of the base plate 2 to reach a position where the contact parts 214 come into contact with the retreat movement preventing units 322, the slider 3 is separated from a position where the base plate 2, the document protective sheet 4, and the document 5 are overlapped with each other to release the pressing at the position, so that the document 5 is not held.

More preferably, in a state where the slider 3 holds the document 5, illustrated in the FIG. 7A, the base plate 2 and the document protective sheet 4 may be sandwiched between a pressing unit 35 provided inside the slider 3 and the movable plate 31 at the end.

In a case where the regulating wall units 21 are provided in the corner parts of the base plate 2, the third ends 323 of the slider 3 come into contact with the second ends 212 of the regulating wall units 21, so that the position is set to the maximum pushing-in position, the single cutting line 20 only needs to be provided near each of the upper and lower corner parts in order to form the regulating wall units 21, and manufacturing efficiency is suitable. However, in a case where such a mode is employed, each time the slider 3 reaches the maximum pushing-in position, force is applied to the regulating wall units 21. When this is considered, the horizontal lengths are set to be long in consideration of the durability of the regulating wall units 21, preferably.

On the other hand, although not illustrated, in a case where the regulating wall units 21 are provided at positions closer to the horizontal center than the corner parts of the base plate 2 (positions closer to the left in FIG. 5), in order to form the regulating wall units 21, the two cutting lines 20 for forming the second end 212 and the contact part 214 need to be arranged side by side in the horizontal direction near the corner part of each of the upper and lower corners. Consequently, the position where the end of the base plate 2 comes into contact with the inner surface of the rising plate 33 becomes the maximum pushing-in position, and therefore the third ends 323 do not come into contact with the second ends 212. In this condition, durability of the regulating wall units 21 does not need to be considered.

That is, if it is considered that manufacturing efficiency is important, the regulating wall units 21 are preferably provided in the corner parts of the base plate 2, and if it is considered that a constitution in which the regulating wall units 21 are unlikely to be deteriorated is important, the regulating wall units 21 are preferably formed at positions closer to the horizontal center than the corner parts of the base plate 2. These may be selected in accordance with various conditions such as the size of a file, and the number of sheets of the document 5 to be stored.

In each of the regulating wall units 21, the first side forming the distal end 211 may be longer than the folding line 213, and the second end 212 and the contact part 214 that are in contact with these may not form parallel relation, so that at least the contact part 214 may not form a right angle with the distal end 211, and a right angle with the folding line 213. In a case where the distal end 211 and the folding line 213 are parallel to each other, the regulating wall unit 21 may be provided so as to form a virtual trapezoid when four virtual lines located on the same lines as the second end 212, contact part 214, distal end 211, and folding line 213 are connected.

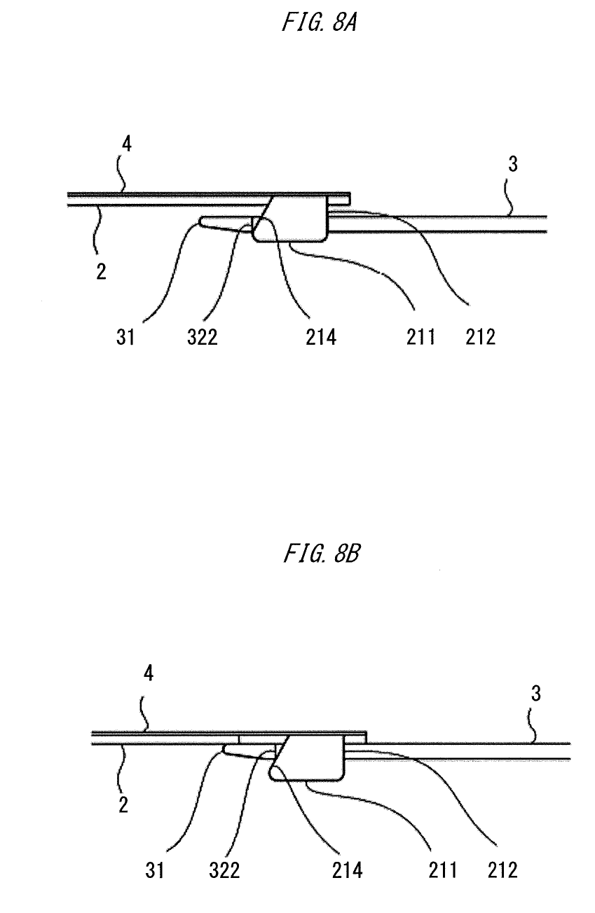

With such a formation, as illustrated in FIG. 8A, when the slider 3 moves in a state where the slider is separated from the base plate 2 in the vertical direction visually recognized in this figure, the contact parts 214 come into contact with the retreat movement preventing units 322. Thereafter, when the slider receives force for further moving in the retreating direction (to the right in this figure), the movable plate 31 moves so as to approach the base plate 2 with upward movement of the retreat movement preventing units 322 in this figure along the inclined contact parts 214. When this action is continued, the slider 3 comes into contact with the base plate 2 as illustrated in FIG. 8B.

In addition, when the file is in a non-holding state illustrated in FIG. 7B and FIG. 8, in order to separate the slider 3 from the base plate 2 in the vertical direction visually recognized in these figures, the slider needs to get over inclinations formed by the contact parts 214 to lower the movable plate 31. That is, in a case where the contact parts 214 are inclined, when the file is in the non-holding state, the slider 3 is unlikely to be detached from the base plate 2.

The present invention is capable of regulating movement of the slider 3 in the direction orthogonal to the movement advancing/retreating direction, or movement of the slider 3 in the retreating direction beyond the maximum pulling-out position, only by providing the cutout parts 32 without connection of another member for regulating the above movement by welding or adhesion.

Additionally, the present invention is capable of regulating movement of the slider 3 in the direction orthogonal to the movement advancing/retreating direction, or movement of the slider 3 in the retreating direction beyond the maximum pulling-out position, only by providing the lug pieces 21 at the corner parts or near the corner parts of the base plate 2 and folding the lug pieces 21 without connecting, to the base plate 2, another member for regulating the above movement by welding or adhesion.

### REFERENCE SIGNS LIST

1 File
2 Base plate
20 Cutting line
21 Lug piece (regulating wall unit)
211 Distal end
212 Second end
213 Folding line
214 Contact part
3 Slider
31 Movable plate
32 Cutout part
321 Orthogonal movement preventing unit
322 Retreat movement preventing unit
323 Third end
33 Rising plate
34 Pressing plate
35 Pressing unit
4 Document protective sheet
5 Document

1. A file comprising:
a base plate; and
a slider slidably provided near an end of the base plate, wherein
the slider sandwiches and files the base plate and a document placed on the base plate by elastic force,
the base plate has regulating wall units erected on both side edges in the end, and
the regulating wall units each regulate movement in a direction orthogonal to an advancing direction toward a holding position where the slider sandwiches the base plate and the document placed on the base plate and a retreating direction toward a non-holding position where the slider is separated from the holding position, and when the slider moves in the retreating direction to reach a predetermined position, the regulating wall units each come into contact with the slider to regulate movement in the retreating direction.

2. The file according to claim 1, wherein the regulating wall units are formed by folding lug pieces obtained by cutting out both side edges in the end of the base plate toward a surface opposite to a surface for allowing the document to be placed in the base plate.

3. The file according to claim 1, wherein the slider has cutout parts at positions that are both side edges of the slider, and face the respective lug pieces in a state where the slider is spliced to the base plate, and has retreat movement preventing units on boundaries between the cutout parts and portions where the cutout parts are not formed in an end of the slider, the retreat movement preventing units being formed to come into contact with the regulating wall units when the slider moves in the retreating direction to reach a predetermined position, and to prevent further movement.

4. The file according to claim 1, wherein the regulating wall units are formed such that distal ends facing folding lines are longer than lengths of the folding lines.
